(19) United States
(12) Patent Application Publication
(10) Pub. No.: US 2024/0078357 A1
(43) Pub. Date: Mar. 7, 2024

(54) METHOD, DEVICE AND ELECTRONIC EQUIPMENT FOR DETECTING STABILITY OF GENERATOR SET IN POWER SYSTEM

(71) Applicant: BEIJING UNIVERSITY OF CIVIL ENGINEERING AND ARCHITECTURE, Beijing (CN)

(72) Inventors: Miao YU, Beijing (CN); Jinyang HAN, Beijing (CN); Jingxuan HU, Beijing (CN); Jiaxin YAN, Beijing (CN); Honghao WU, Beijing (CN); Jianqun SUN, Beijing (CN)

(21) Appl. No.: 18/459,349

(22) Filed: Aug. 31, 2023

(30) Foreign Application Priority Data
Sep. 6, 2022 (CN) 202211085935.5

(51) Int. Cl. G06F 30/20; G06F 30/18

(52) U.S. Cl. CPC G06F 30/20; G06F 30/18; G06F 2119/02

(57) ABSTRACT

Provided are a method, a device and electronic equipment for detecting a stability of a generator set in a power system. The method includes following steps: determining a target matrix by using Liapunov's direct method based on a state space matrix corresponding to power management unit (PMU) data; obtaining a state deviation corresponding to the PMU data and an oscillation curve corresponding to the state deviation in a case of determining the power system being in a stable state according to the target matrix; determining extreme point values corresponding to the oscillation curve at each oscillation; and evaluating a working state of the generator set in the power system according to the extreme point values.

### CROSS-REFERENCE TO RELATED APPLICATIONS

This application claims priority to Chinese Patent Application No. 202211085935.5, filed on Sep. 6, 2022, the contents of which are hereby incorporated by reference.

### TECHNICAL FIELD

The disclosure relates to a technical field of power system detection, and in particular to a method, a device and electronic equipment for detecting stability of a generator set in a power system.

### BACKGROUND

With the development of power electronization of core equipment in the power system and the rapid change of new energy generation, the current power system presents a “double-big” development trend, a big proportion of renewable energy and a big proportion of power electronic equipment. At the same time, due to continuous popularization of high-voltage and large-capacity converter equipment in the transmission network and a wide application of power electronics technology on the distribution side, the “double-big” characteristic of the power system is more obvious. In addition, the “double-big” characteristic has gradually become an important technical feature of the new generation power system, so it is gradually necessary to study the small disturbance stability of the “double-big” power system.

In this “double-big” power system, large-scale synchronous generator sets are replaced by small-scale power sources, and new devices with power electronics as interfaces, such as mass distributed power sources, electric vehicles and distributed energy storage, are connected to the power system from the middle and low voltage side, thus making the number of dynamic elements to be considered in stability analysis may reach the order of one hundred thousand to one million, and the dynamic characteristics of various generator sets are relatively different, showing a high degree of heterogeneity.

In the prior art, when analyzing the small disturbance stability of the above-mentioned “double-big” power system, electronic equipment faces severe challenges such as a computational burden and a communication burden caused by high data dimension. In addition, the operating position of the power system also changes rapidly due to the fluctuation caused by new energy supply, frequent switching from a large number of power electronic equipment and high-speed changes in the system topology. To sum up, because the existing process of determining the stability of the power system is complicated, the electronic equipment cannot accurately judge the stability of the power system.

### SUMMARY

The disclosure provides a method, a device and electronic equipment for detecting stability of a generator set in a power system, so as to solve the defect that the existing process for determining the stability of the power system is complicated, and the electronic equipment may not accurately judge the stability of the power system, and to realize that the electronic equipment may accurately determine the stability of the power system based on power management unit (PMU) data with a large amount of data by using Liapunov's direct method.

The disclosure provides a method for detecting the stability of the generator set in the power system, including following steps:
determining a target matrix by using Liapunov's direct method based on a state space matrix corresponding to PMU data;
obtaining a state deviation corresponding to the PMU data and an oscillation curve corresponding to the state deviation in a case of determining the power system being in a stable state according to the target matrix;
determining extreme point values corresponding to the oscillation curve at each oscillation; and
evaluating a working state of the generator set in the power system according to the extreme point values.

According to the method for detecting the stability of the generator set in the power system provided by the disclosure, where the determining the target matrix by using Liapunov's direct method based on the state space matrix corresponding to PMU data includes following steps: determining the state space matrix according to the acquired PMU data and based on a generator state space model; analyzing the state space matrix by using Liapunov's direct method and determining the target matrix.

According to the method for detecting the stability of the generator set in the power system provided by the disclosure, where the determining the power system being in the stable state according to the target matrix includes a following step: determining the power system being in the stable state under a condition of determining the target matrix being a positive definite matrix.

According to the method for detecting the stability of the generator set in the power system provided by the disclosure, where the determining the extreme point values corresponding to the oscillation curve at each oscillation includes a following step: determining a first extreme point value corresponding to a peak and a second extreme point value corresponding to a trough of the oscillation curve at each oscillation by using a gradient descent method.

According to the method for detecting the stability of the generator set in the power system provided by the disclosure, where the evaluating the working state of the generator set in the power system according to the extreme point values includes following steps: performing a weighted summation on each extreme point data to obtain an extreme value deviation; evaluating the working state of the generator set in the power system according to the extreme value deviation.

According to the method for detecting the stability of the generator set in the power system provided by the disclosure, where the evaluating the working state of the generator set in the power system according to the extreme value deviation includes following steps: determining that an oscillation degree of the generator set in the power system is not severe when the extreme value deviation is less than a preset deviation threshold; and determining that the oscillation degree of the generator set is severe when the extreme value deviation is greater than or equal to the preset deviation threshold.

According to the method for detecting the stability of the generator set in the power system provided by the disclosure, where the determining the state space matrix according to the acquired PMU data and based on the generator state space model includes following steps: summarizing the acquired PMU data to obtain power grid data; carrying out a dimensionality reduction pretreatment on the power grid data to obtain a data matrix; and determining the state space matrix according to the data matrix and based on the generator state space model.

The disclosure also provides a device for detecting stability of a generator set, including:
a data processing module used for determining a target matrix by using Liapunov's direct method based on a state space matrix corresponding to PMU data; obtaining a state deviation corresponding to the PMU data and an oscillation curve corresponding to the state deviation in a case of determining the power system being in a stable state according to the target matrix; and determining extreme point values corresponding to the oscillation curve at each oscillation;
and a stability determination module used for evaluating a working state of the generator set in the power system according to the extreme point values.

The disclosure also provides electronic equipment, including a memory, a processor and a computer program stored in the memory and executable on the processor, when the processor executes the program, the method for detecting the stability of the generator set in the power system may as described in any of the above is realized.

The disclosure also provides a non-transient computer-readable storage medium, the computer program is stored on the non-transient computer-readable storage medium, and when the computer program is executed by the processor, the method for detecting the stability of the generator set in the power system as described in any of the above is realized.

The disclosure also provides a computer program product, including a computer program, and when the computer program is executed by the processor, the method for detecting the stability of the generator set in the power system as described in any of the above is realized.

According to the method, the device and the electronic equipment for detecting the stability of the generator set in the power system provided by the embodiment, determining a target matrix by using Liapunov's direct method based on a state space matrix corresponding to the PMU data; obtaining a state deviation corresponding to the PMU data and an oscillation curve corresponding to the state deviation in a case of determining the power system being in a stable state according to the target matrix; determining extreme point values corresponding to the oscillation curve at each oscillation; and evaluating a working state of the generator set in the power system according to the extreme point values. The method provided by the embodiment is used to solve the defect that the existing process for determining the stability of the power system is complicated, so that the electronic equipment cannot accurately judge the stability of the power system, and to realize that the electronic equipment may accurately determine the stability of the power system based on the PMU data with a large amount of data by using Liapunov's direct method.

### BRIEF DESCRIPTION OF THE DRAWINGS

In order to explain the technical scheme of the present disclosure or the prior art more clearly, the drawings needed in the description of the embodiments or the prior art are briefly introduced below. Obviously, the drawings in the following description are some embodiments of the present disclosure, and other drawings may be obtained according to these drawings without creative labor for ordinary people skilled in the art.

FIG. 1 is a flowchart of a method for detecting a stability of a generator set in a power system provided by the present disclosure.

FIG. 2A is a graph showing power angle oscillation curves respectively corresponding to each generator set unconfigured with power system stabilizer (PSS) in a simulation system provided by the present disclosure.

FIG. 2B is a graph showing oscillation curves respectively corresponding to different power units in a power system unconfigured with PSS provided by the present disclosure.

FIG. 2C is a graph showing oscillation curves respectively corresponding to power systems configured with different PSS provided by the present disclosure.

FIG. 3 is a structural schematic diagram of a device for detecting a stability of a generator set provided by the present disclosure.

FIG. 4 is a schematic structural diagram of electronic equipment provided by the present disclosure.

### DETAILED DESCRIPTION OF THE EMBODIMENTS

In order to make the purpose, technical scheme and advantages of the present disclosure clearer, the technical scheme in the present disclosure is described clearly and completely with reference to the drawings. Obviously, the described embodiments are part of the embodiments of the present disclosure, but not all of the embodiments. Based on the embodiments in the present disclosure, all other embodiments obtained by ordinary technicians in the field without creative labor belong to the scope of protection of the present disclosure.

It should be noted that the electronic equipment related to the embodiment of the present disclosure may be a power system or a terminal equipment associated with the power system (“associated equipment” for short), and no specific limitation is made here.

The power system may be a “double-big” power system, referring to a system with a big proportion of renewable energy and a big proportion of power electronic equipment.

Optionally, in a case that the electronic equipment is a terminal device associated with the power system, the electronic equipment may include, but is not limited to: computers, mobile terminals, wearable devices and the like.

Optionally, the associated equipment and the power system may be connected through the wireless communication technology, the wireless communication technology may include but not limited to one of the following: the 4th generation mobile communication technology (4G), the 5th generation mobile communication technology (5G) and Wireless Fidelity (WiFi).

It should be noted that the executive agent involved in the embodiment of the present disclosure may be a device for detecting stability of a generator set or electronic equipment, and the embodiment of the present disclosure is further explained by taking the electronic equipment as an example.

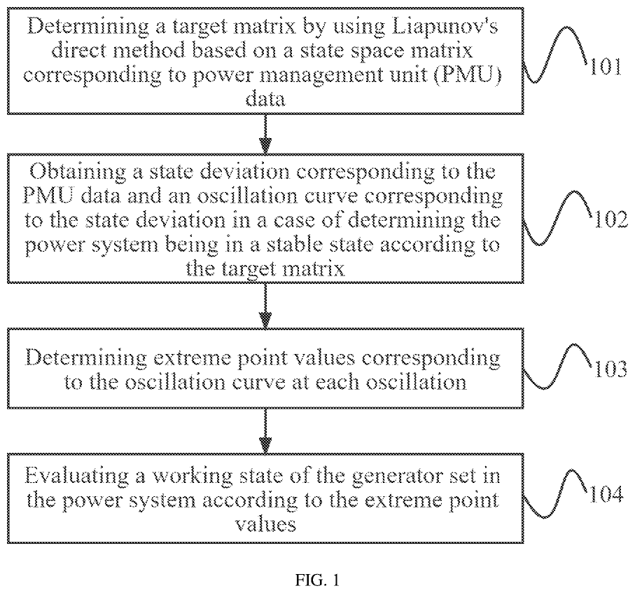

As shown in FIG. 1, it is a flowchart of a method for detecting stability of a generator set in a power system provided by the present disclosure, including:
101, determining a target matrix by using Liapunov's direct method based on a state space matrix corresponding to power management unit (PMU) data;
where the PMU data refers to the data obtained by the electronic equipment after using the PMU to measure the generator set in the power system during operation, that is, using the PMU to provide the power system data monitored under real conditions;
the state space matrix refers to a matrix corresponding to PMU data obtained by the electronic equipment based on a generator state space model, and may be represented by A;
the target matrix refers to a matrix obtained by the electronic equipment after a series of operations on the above state space matrix, and may be expressed by P;
Liapunov's direct method, also known as Liapunov's second method, refers to directly inferring the stability of power system by means of Liapunov's energy function and the symbolic properties of the derivative of energy function along the trajectory calculated according to differential equations.

Optionally, PMU data may include, but not limited to, rotate speed increment, power angle increment, electromagnetic power increment, damping moment constant and inertia time constant corresponding to the generator set.

After acquiring the PMU data in real time, the electronic equipment may perform a series of operations on the state space matrix corresponding to the PMU data to obtain the target matrix corresponding to the PMU data.

It should be noted that for an unified inertia center in the whole power system, when oscillation occurs in a certain area of the power system, there are always deceleration and acceleration units showing a relative swing between two generator sets, the two generator sets may be simplified as an interconnected power system equivalent composed of two equivalent generator sets.

In some embodiments, the electronic equipment determines the target matrix based on the state space matrix corresponding to the PMU data by using Liapunov's direct method, where following steps may be specifically included: the electronic equipment determines the state space matrix according to the acquired PMU data and based on a generator state space model; and the electronic equipment analyzes the state space matrix by using Liapunov's direct method and determines the target matrix.

The generator state space model refers to a second-order model obtained by the electronic equipment after reducing the order of a synchronous generator model, the synchronous generator model corresponds to rotor motion equations of the two equivalent generator sets.

Based on the generator state space model and Liapunov's direct method, the electronic equipment may accurately obtain the target matrix corresponding to the PMU data.

Optionally, the electronic equipment determines the state space matrix according to the acquired PMU data and based on a generator state space model, where following steps may be specifically included: the electronic equipment determines the state space matrix based on the rotor motion equations in the generator state space model according to the acquired PMU data.
where the rotor motion equations are:

$$\{ \begin{matrix}Δ {\dot{δ}}_{1} = Δ {ω}_{1} \\ Δ {\dot{δ}}_{2} = Δ {ω}_{2} \\ Δ {\dot{ω}}_{1} = \frac{- Δ {P}_{1 e} - {D}_{1} Δ {ω}_{1}}{{M}_{1}} \\ Δ {\dot{ω}}_{2} = \frac{- Δ {P}_{2 e} - {D}_{2} Δ {ω}_{2}}{{M}_{2}}\end{matrix} ;$$

Δ\dot{δ}₁ represents a first rotate speed increment corresponding to a first generator set; Δω1 represents a first power angle increment corresponding to the first generator set; Δ\dot{δ}₂ represents a second rotate speed increment corresponding to a second generator set; Δω₂ represents a second power angle increment corresponding to the second generator set; Δ\dot{ω}₁ represents an equivalent power angle increment corresponding to the first generator set; ΔP₁ₑ represents a first electromagnetic power increment corresponding to the first generator set; D₁ represents a first damping torque constant corresponding to the first generator set; M₁ represents a first inertia time constant corresponding to the first generator set; Δ\dot{ω}₂ represents an equivalent power angle increment corresponding to the second generator set; ΔP₂ₑ represents a second electromagnetic power increment corresponding to the second generator set; D₂ represents a second damping torque constant corresponding to the second generator set; M₂ represents a second inertia time constant corresponding to the second generator set.
where the state space matrix

$$A = [ \begin{matrix}0 & 0 & 1 & 0 \\ 0 & 0 & 0 & 1 \\ - \frac{{K}_{12}}{{M}_{1}} & \frac{{K}_{12}}{{M}_{1}} & - \frac{{D}_{1}}{{M}_{1}} + \frac{{K}_{13}}{{M}_{1}} & 0 \\ - \frac{{K}_{12}}{{M}_{2}} & \frac{{K}_{12}}{{M}_{2}} & \frac{{K}_{12}}{{M}_{2}} & - \frac{{D}_{2}}{{M}_{2}}\end{matrix} ] ;$$

in the state space matrix A,

$${K}_{12} = \frac{{k}_{1} {k}_{2}}{{k}_{1} + {k}_{2}} ; {K}_{13} = \frac{{k}_{1} {k}_{3}}{{k}_{1} + {k}_{3}} ;$$

an electromagnetic power equation may be expressed as:

$$\{ \begin{matrix}Δ {P}_{1 e} = {k}_{1} ( Δ {δ}_{1} - Δ {δ}_{w} ) \\ Δ {P}_{2 e} = {k}_{2} ( Δ {δ}_{w} - Δ {δ}_{2} )\end{matrix} ;$$

a dynamic active power of the wind farm is expressed as:

$$\{ \begin{matrix}Δ {P}_{w 1} = {k}_{3} Δ {ω}_{1} \\ Δ {P}_{w 2} = {k}_{4} Δ {ω}_{2}\end{matrix} ;$$

K₁₂ represents a first target constant, k₁ represents a first sub-constant, k₂ represents a second sub-constant, K₁₃ represents a second target constant, k₃ represents a third sub-constant, k₄ represents a fourth sub-constant, Δδ₁ represents a first rotate speed increment, Δδ₂ represents a second rotate speed increment, Δδ_{w} represents a third rotate speed increment, ΔP_{w1} represents a first dynamic active power, and ΔP_{w2} represents a second dynamic active power.

After obtaining the PMU data, the electronic equipment accurately determines the state space matrix corresponding to the PMU data based on the rotor motion equations in the generator state space model.

It should be noted that the rotor motion equations are performed with order-reduction derivation by the electronic equipment based on formulas in the synchronous generator model, and the specific order-reduction derivation process is as follows: the formulas in the synchronous generator model include: voltage equation of f winding, voltage equation of g winding, voltage equation of D winding, voltage equation of Q winding and first motion equation of rotor;
where the voltage equation of the f winding is:

$${T}_{d 0}^{′} {pE}_{q}^{′} = {E}_{f} - \frac{{X}_{d} - {X}_{1}}{{X}_{d}^{′} - {X}_{1}} {E}_{q}^{′} + \frac{{X}_{d} - {X}_{d}^{′}}{{X}_{d}^{′} - {X}_{1}} {E}_{q}^{″} - \frac{( {X}_{d} - {X}_{d}^{′} ) ( {X}_{d}^{″} - {X}_{1} )}{{X}_{d}^{′} - {X}_{1}} {i}_{d} ,$$

where T_{d0}′ represents an inertia time constant corresponding to the f winding, p represents a number of pole-pairs corresponding to the f winding, E_{q}′ represents a transient no-load electromotive force corresponding to the f winding, E_{f} represents a magnetomtive force, X_{d} represents a first steady-state reactance corresponding to the f winding, X_{d}′ represents transient reactance corresponding to the f winding, X₁ represents a second steady-state reactance corresponding to the f winding, E_{q}″ represents a secondary transient no-load electromotive force corresponding to the f winding, X_{d}″ represents a secondary transient reactance corresponding to the f winding, and i_{d} represents an alternating component corresponding to the f winding;
the voltage equation of the g winding is:

$${T}_{q 0}^{′} {pE}_{d}^{′} = - \frac{{X}_{q} - {X}_{1}}{{X}_{q}^{′} - {X}_{1}} {E}_{d}^{′} + \frac{{X}_{q} - {X}_{q}^{′}}{{X}_{q}^{′} - {X}_{1}} {E}_{d}^{″} + \frac{( {X}_{q} - {X}_{q}^{′} ) ( {X}_{q}^{″} - {X}_{1} )}{{X}_{q}^{′} - {X}_{1}} {i}_{q} ,$$

where T_{q0}′ represents an inertia time constant corresponding to the g winding, X_{q} represents a steady-state reactance corresponding to the g winding, X_{q}′ represents a transient parameter reactance corresponding to the g winding, X_{q}″ represents a secondary transient reactance corresponding to the g winding, and i_{q} represents an alternating component corresponding to the g winding;
the voltage equation of the D winding is:

$${T}_{d 0}^{″} {pE}_{d}^{″} = - \frac{{X}_{d}^{″} - {X}_{1}}{{X}_{d}^{′} - {X}_{1}} {T}_{d 0}^{″} {pE}_{q}^{′} + {E}_{q}^{′} - ( {X}_{d}^{′} - {X}_{d}^{″} ) {i}_{d} - {E}_{q}^{″} ,$$

where T_{d0}″ represents an inertia time constant corresponding to the D winding;
the voltage equation of the Q winding is:

$${T}_{q 0}^{″} {pE}_{d}^{″} = - \frac{{X}_{q}^{″} - {X}_{1}}{{X}_{q}^{′} - {X}_{1}} {T}_{q 0}^{″} {pE}_{d}^{′} + {E}_{d}^{′} - ( {X}_{q}^{′} - {X}_{q}^{″} ) {i}_{q} - {E}_{d}^{″} ,$$

where T_{q0}″ represents an inertia time constant corresponding to the Q winding;
the first motion equation of the rotor is:

$$\{ \begin{matrix}{T}_{J} \frac{d ω}{dt} = {T}_{m} - {E}_{q}^{″} {i}_{q} - {E}_{d}^{″} {i}_{d} + ( {X}_{d}^{″} - {X}_{q}^{″} ) {i}_{q} {i}_{d} \\ \frac{d δ}{dt} = ω - 1\end{matrix} ,$$

where Tⱼ represents an inertia time constant corresponding to the rotor, Tₘ represents a first time constant corresponding to the rotor, co represents a power angle corresponding to the rotor, also known as an angular velocity, δ represents a rotate speed of the rotor, and t represents a motion time of the rotor.

Then when the electronic equipment analyzes the small disturbance stability of the power system, that is, the stability of motor components in the power system, in order to reduce the order of state equations in the power system and avoid the problem of inaccurate stability judgment caused by too high order, as the time constant of each rotor damping winding is small, the electronic equipment may appropriately ignore the windings corresponding to these rotor damping windings in practical application analysis. When the electronic equipment ignores the effects of equivalent D-axis, Q-axis and g-axis of damping winding and only considers the transient process of excitation winding and the third-order model of rotor dynamics, the system where the excitation winding is located may be represented by a first-order linear link. At this time, the electronic equipment may reduce the above-mentioned synchronous generator model to a third-order model, the state quantities in the third-order model are the transient no-load electromotive force E_{q}′, the angular velocity w and the rotate speed δ respectively, and the third-order model may include: generator excitation winding equation, stator voltage equation and second motion equation of the rotor.

The generator excitation winding equation is: T_{d0}′pE_{q}′=E_{f}−E_{q}′−(X_{d}−X_{d}′)i_{d};
the stator voltage equation is: U_{d}=X_{q}i_{q}−rₐi_{d}, U_{q}=E_{q}′−X_{d}i_{d}−rₐi_{q}, where U_{d} represents a first voltage corresponding to the stator, U_{q} represents a second voltage corresponding to the stator, and rₐ represents a resistance corresponding to the stator; and
the second motion equation of the rotor is

$${T}_{J} \frac{d ω}{dt} + D ( ω - 1 ) = {T}_{m} - {E}_{q}^{′} {i}_{q} + ( {X}_{d}^{′} - {X}_{q} ) {i}_{q} {i}_{d} , \frac{d δ}{dt} = ω - 1.$$

Then the electronic equipment may further ignore the transient process of the f winding, and reduce the above-mentioned third-order model to a classic second-order practical model of the generator, may be also known as the constant impedance model of the load:

$$\{ \begin{matrix}{U}_{d} = {X}_{q} {i}_{q} - {r}_{a} {i}_{d} \\ {U}_{q} = {E}_{q}^{′} - {X}_{d}^{′} {i}_{d} - {r}_{a} {i}_{q} \\ {T}_{J} \frac{d ω}{dt} = {T}_{m} - {E}_{q}^{′} {i}_{q} + ( {X}_{d} - {X}_{q} ) {i}_{q} {i}_{d} - D ( ω - 1 ) \\ \frac{d δ}{dt} = ω - 1\end{matrix}$$

Finally, when the electronic equipment adopts the classic second-order practical model of the generator, the above process may be equivalent to the rotor motion equations of two equivalent generator sets, that is, the above process may be equivalent to the generator state space model.

Optionally, the electronic equipment uses Liapunov's direct method to analyze the state space matrix and to determine the target matrix, where following steps may be specifically included: the electronic equipment substitutes the state space matrix into the linear fixed constant system state equation and the matrix formula in Liapunov's direct method to obtain the target matrix.

The state equation of the linear fixed constant system is: \dot{x}=Ax;
the matrix formula is A^{T}P+PA=−Q;
\dot{x} represents a balance point; x represents an equilibrium state point; A represents the state space matrix; A^{T} represents a transposition of the state space matrix A; Q represents a preset positive definite matrix in Liapunov's direct method.

Optionally, the preset positive definite matrix Q is an arbitrary real symmetric matrix, and in order to simplify the determination process of the target matrix, the preset positive definite matrix Q may be an identity matrix I.

In some embodiments, the electronic equipment determines the state space matrix based on the generator state space model according to the acquired PMU data, where following steps may be specifically included: the electronic equipment summarizes the acquired PMU data to obtain power grid data; the electronic equipment performs the dimensionality reduction pretreatment on the power grid data to obtain a data matrix; and the electronic equipment determines the state space matrix based on the generator state space model according to the data matrix.

The dimensionality reduction pretreatment refers to a process that electronic equipment reduces the first dimension of power grid data to obtain the data matrix of the second dimension, and the first dimension is greater than the second dimension.

After obtaining the PMU data in real time, the electronic equipment may first summarize the PMU data to form power grid data, that is, obtain an initial data matrix corresponding to the PMU data; then, the electronic equipment pretreats the power grid data to obtain the data matrix needed by the generator state space model; and finally, the electronic equipment may accurately obtain the state space matrix A corresponding to the PMU data based on the data matrix and the generator state space model.

102, obtaining a state deviation corresponding to the PMU data and an oscillation curve corresponding to the state deviation in a case of determining the power system being in a stable state according to the target matrix;
where the state deviation may be understood as the deviation of the oscillation curve from the stable equilibrium point at a certain moment, and the state deviation is not used in the stability qualitative judgment stage of the power system, and is mainly used to quantitatively describe the oscillation amplitude and oscillation duration of a monitored state quantity of the electronic equipment relative to the equilibrium point of the electronic equipment after the electronic equipment is judged to be stable, that is, the state deviation may be regarded as the severity of the oscillation of the power system;
the oscillation curve refers to the corresponding curve when the generator set oscillates during operation, and the oscillation curve may include peaks and troughs.

After obtaining the target matrix, the electronic equipment may judge whether the power system is in a static and stable state based on the target matrix; under the condition that the power system is determined to be in a static and stable state according to the target matrix, the electronic equipment may obtain the state deviation corresponding to the PMU data and the oscillation curve corresponding to the state deviation, so as to judge the dynamic stable state of the power system.

Optionally, before or after the step 102, the method may further include: when determining that the power system is not in a static and stable state according to the target matrix, the electronic equipment may output first prompt information, and the first prompt information is used to prompt the user that the power system is unstable, so that the user may know that the power system is not stable enough in time and take corresponding measures to make the power system stable. At this time, the electronic equipment may obtain the state deviation corresponding to the PMU data and the oscillation curve corresponding to the state deviation.

Optionally, the electronic equipment obtains the state deviation corresponding to PMU data may include: the electronic equipment obtains a state variable integral value of the i-th state deviation corresponding to the PMU data based on an integral value formula.

The integral value formula is J=∫₀^{∞}x^{T}Q_{J}xdt;

J represents the state variable integral value of the i-th state deviation; x^{T} represents a transposition of the equilibrium state point x; Q_{J}=diag (q1, . . . , qj, . . . , qn) represents a diagonal matrix corresponding to the PMU data, and qⱼ represents the j-th element. This diagonal matrix Q_{J} j only takes the corresponding diagonal matrix element as 1 and the rest as 0, for example, Q_{J}=diag (1, . . . , 1, 0, . . . , 0).

In order to simplify the whole process of determining the integral value of the state variable of the i-th state deviation, the electronic equipment may bring the identity matrix I into Q_{J} to obtain J=−∫₀^{∞}(x^{T}A^{T}Pⱼx+x^{T}P_{J}Ax)dt, and then obtain J=x^{T}P_{J}x, where P_{J} represents the target matrix corresponding to the i-th state deviation.

In this way, the electronic equipment may obtain the state variable integral values corresponding to at least one state deviation, that is, obtain at least one state variable integral value based on the above integral value formula.

It should be noted that the state variable integral value J may reflect the dynamic stability of the power system state deviation, that is, the dynamic stability; the smaller the state variable integral value J, the faster the attenuation speed of the state deviation and the smaller the oscillation amplitude of the oscillation curve, and the shorter the duration of the whole dynamic stability process, the better the small disturbance stability of the power system; the greater the state variable integral value J showing that the slower the attenuation speed of the state deviation and the larger the oscillation amplitude of oscillation curve, the longer the whole dynamic stability process, and the worse the small disturbance stability of the power system.

In some embodiments, the electronic equipment determines that the power system is in a static and stable state according to the target matrix, where following steps may be specifically included: the electronic equipment determines that the power system is in a static and stable state under the condition that the target matrix is a positive definite matrix.

The positive definite matrix refers to a matrix with all-positive eigenvalues, all-positive principal minors of each order, and congruent with the identity matrix.

After acquiring the target matrix, the electronic equipment may judge whether the target matrix is the positive definite matrix; the electronic equipment may determine that the target matrix is the positive definite matrix when determining that the eigenvalues of the target matrix are all positive, that the principal minors of each order of the target matrix are all positive and that the target matrix is congruent with the identity matrix, and at this time, the electronic equipment may accurately determine that the power system is in a static and stable state.

103, determining extreme point values corresponding to the oscillation curve at each oscillation.

The extreme point values refer to the first extreme point value corresponding to the peak generated by the oscillation curve during oscillation and the second extreme point value corresponding to the trough generated by the oscillation curve during oscillation.
the oscillation curve produces peaks and troughs when oscillating, and the electronic equipment only needs to obtain the first extreme point value corresponding to the peak and the second extreme point value corresponding to the trough generated during each oscillation.

In some embodiments, the electronic equipment determines the extreme point values of the oscillation curve at each oscillation, and following steps may be specifically included: the electronic equipment determines the first extreme point value corresponding to the peak and the second extreme point value corresponding to the trough of the oscillation curve at each oscillation by using the gradient descent method.

The gradient descent method refers to a time-weighted value based on the gradient descent deviation of the oscillation curve, and is used to describe the low-frequency oscillation process of a single state deviation, and may analyze and evaluate the dynamic process of the state deviation and the dynamic stability process of the power system.

When analyzing each generator set in the power system, in order to simplify the calculation process and have an effect similar to the above-mentioned state deviation, the electronic equipment may determine the first extreme point value corresponding to the peak and the second extreme point value corresponding to the trough of the oscillation curve at each oscillation by the gradient descent method.

After obtaining the oscillation curve, the electronic equipment may take the oscillation curve as the objective function in the gradient descent method, and the objective function is x(t)=x(t₁), . . . x(tₘ), . . . x(tₙ), where x(tₘ) represents the m-th independent variable corresponding to the oscillation curve; then the electronic equipment performs gradient descent iteration on the objective function as follows: when θ>0, the electronic equipment may obtain the following iteration formulas:

$${t}_{1}^{( θ + 1 )} = {t}_{1}^{( θ )} - η \frac{df}{{dt}_{1}} t ( θ ) , … , {t}_{m}^{( θ + 1 )} = {t}_{m}^{( θ )} - η \frac{df}{{dtt}_{m}} {t}^{( θ )} , … , {t}_{n}^{( θ + 1 )} = {t}_{n}^{( θ )} - η \frac{df}{{dt}_{n}} {t}^{( θ )} ,$$

θ represents the number of iterations, and η represents the iteration constant; in the whole process of gradient descent iteration, when the iteration reaches the convergence condition, that is, when the gradient is zero point, the extreme value corresponding to the zero point is obtained, the electronic equipment does not perform gradient descent iteration on the objective function any more. From these iterative formulas of the gradient descent method, the choice of the next time point is related to the position of the current time point and the gradient of the current time point. For the electronic equipment to calculate the maximum value of the objective function, the electronic equipment may advance in the opposite direction of the time gradient; then the electronic equipment repeats the process of gradient descent iteration, so that the first extreme point value corresponding to the peak and the second extreme point value corresponding to the trough of the oscillation curve at each oscillation may be determined.

In addition, according to the whole process of obtaining the extreme value, whether the electronic equipment determines the maximum value of the objective function or the minimum value of the objective function, the electronic equipment needs to construct a following iterative relationship: g(t)=t−ηƒ(t).

In this way, the electronic equipment may record the corresponding time of the whole oscillation curve in the oscillation process in real time after determining that the power system is in a static and stable state according to the target matrix; then the electronic equipment uses the gradient descent method on the oscillation curve to accurately determine the extreme point values corresponding to the oscillation curve at each oscillation.

104, evaluating a working state of the generator set in the power system according to the extreme point values.

In some embodiments, the electronic equipment evaluates the working state of the generator set in the power system according to the extreme point values, where following steps may be specifically included: the electronic equipment performs the weighted summation on each extreme point data to obtain the extreme value deviation; the electronic equipment evaluates the working state of the generator set in the power system according to the extreme value deviation.

Different extreme points correspond to different weights. After obtaining the extreme point values, the electronic equipment may perform the weighted summation on each extreme point value and weights corresponding to each extreme point value to obtain the extreme value deviation corresponding to the generator set, that is, may the extreme value deviation of the oscillation curve in the oscillation process may be determined; then according to the extreme value deviation, the electronic equipment determines the oscillation severity of the generator set in the power system, so as to determine the stability of the generator set, that is, the electronic equipment may determine whether the generator set in the power system is stable or unstable according to the magnitude of the extreme value deviation, and no specific qualification is made here.

In addition, the extreme value deviation of the state variable of electronic equipment, that is, an extreme value deviation difference of the oscillation curve obtained by the gradient descent method of the electronic equipment, is different from the integral value of the state deviation (J), and is mainly used to evaluate the oscillation amplitude of the state variable of the electronic equipment more quickly and efficiently through calculation.

In some embodiments, the electronic equipment evaluates the working state of the generator set in the power system according to the extreme value deviation, where following steps may be specifically included: the electronic equipment determines that an oscillation degree of the generator set in the power system is not severe when the extreme value deviation is less than a preset deviation threshold; the electronic equipment determines that the oscillation degree of the generator set is severe when the extreme value deviation is greater than or equal to the preset deviation threshold.

The preset deviation threshold may be set before the electronic equipment leaves the factory, or may be obtained by the user according to a large number of simulation experimental data, and no specific qualification is made here.

In the process of determining the working state of the generator set in the power system according to the extreme value deviation, the electronic equipment may compare the extreme value deviation with the preset deviation: when the extreme value deviation is less than the preset deviation threshold, it means that the extreme value deviation is small, and at this time, and it may be determined that the oscillation degree of the generator set is not severe; when the extreme value deviation is greater than or equal to the preset deviation threshold, it means that the extreme value deviation is large, and at this time, and it may be determined that the oscillation degree of the generator set is severe.

Optionally, after the electronic equipment determines that the oscillation degree of the generator set is severe, the method may further include: the electronic equipment outputs a second prompt message, the second prompt message is used to prompt the user that the generator set in the power system is unstable, so that the user may timely acquire that the generator set is unstable and take corresponding measures, for example, a power system stabilizer (PSS) is added to the generator set, so that the generator set may tend to be stable during operation.

In the embodiment of the disclosure, determining a target matrix by using Liapunov's direct method based on a state space matrix corresponding to PMU data; obtaining a state deviation corresponding to the PMU data and an oscillation curve corresponding to the state deviation in a case of determining the power system being in a stable state according to the target matrix; determining extreme point values corresponding to the oscillation curve at each oscillation; and evaluating a working state of the generator set in the power system according to the extreme point values. The method provided by the embodiment is used to solve the defect that the existing process for determining the stability of the power system is complicated, and the electronic equipment cannot accurately judge the stability of the power system, and to realize that the electronic equipment may accurately determine the stability of the power system based on PMU data with a large amount of data by using Liapunov's direct method.

For example, according to the method for detecting the stability of the generator set in the power system shown in FIG. 1, the generator set in the power system is simulated, and the process is as follows:

In the process of analyzing the power system with small disturbance stability by the direct method, the electronic equipment obtains the amplitude and phase angle of current and voltage collected when the corresponding duration of the PMU data is 0 second (s) to 1.179 s resorting to the PMU data actually measured by the existing New England system. Then, the electronic equipment summarizes and reduces the dimension of the PMU data to obtain the data matrix needed by the generator state space model; then the electronic equipment brings the data matrix into the state space matrix A, and takes the IEEE 10-machine 39-node New England system as the simulation system. For the state space matrix A, the small disturbance stability of the simulation system is analyzed and calculated by Liapunov's direct method. Optionally, in the simulation process, the electronic equipment uses MATLAB to design the algorithm program for stability judgment and index function value calculation. Then, the electronic equipment uses the above algorithm steps to judge stabilities of WSCC 3-machine system, China Electric Power Research Institute 6-machine system and New England 10-machine system respectively by eigenvalue method and Liapunov's direct method. The stability judgment results of different simulation systems are shown in Table 1:

TABLE 1

| | Whether the | Whether the target matrix |
|---|---|---|
| | eigenvalue λ | P is positive definite |
| Simulation system | less than 0 | (whether P is greater than 0) |
| WSCC 3-machine system | Yes | Yes |
| China Electric Power | Yes | Yes |
| Research Institute 6- | | |
| machine system | | |
| New England 10-machine | No | No |
| system | | |

The eigenvalue method refers to judging the stability of power system by analyzing the relationship between eigenvalues and state variables. The electronic equipment may calculate the eigenvalue and eigenvector of the corresponding matrix of the power system according to the power system linearization model in the form of state equation, and then judge the stability of the power system according to the eigenvalue and eigenvector.

As may be seen from Table 1, the results of electronic equipment are consistent whether using eigenvalue method or Liapunov's direct method. Therefore, the Liapunov's direct method applied by the disclosure may accurately and reliably determine the stability of different power systems, and the results obtained by the two judgment methods are not inconsistent because some parameters are omitted.

In the process of analyzing the low-frequency oscillation of power system by the electronic equipment, the minimum damping ratio of the electromechanical mode is often used as the evaluation index of low-frequency oscillation when the power system has small interference. In the prior art, the existing electronic equipment may configure the power system with damping stability controller PSS according to the dynamic minimum damping ratio configuration criterion, and the minimum damping ratio obtained by the eigenvalue method is given. The square integral value method of dynamic deviation of the power system involved in this disclosure is to establish Liapunov's equation set by using the state space matrix A, call Liapunov's equation function in MATLAB to solve the target matrix P, and judge the positive definiteness of the target matrix P, so as to judge the stability of the power system by using Liapunov's direct method. According to the dynamic deviation method mentioned above, the electronic equipment obtains the index function value with the help of Liapunov's equation, that is, the electronic equipment obtains the weighted square integral value of each state deviation of in the oscillation curve of the power system, the weighted square integral value may reflect the dynamic performance of the extreme value deviation of the power system. As shown in Table 2, it is the relationship table between the unit configured with PSS and the minimum damping ratio and the square integral value of dynamic deviation provided by the present disclosure:

TABLE 2

| Units configured with PSS | Minimum damping ratio |
|---|---|
| 1, 2 | 0.0243 |
| 1, 2, 9, | 0.0245 |
| 1, 2, 9, 7, | 0.0272 |
| 1, 2, 9, 7, 4 | 0.0288 |
| 1, 2, 9, 7, 4, 5 | 0.0654 |
| 1, 2, 9, 7, 4, 5, 3 | 0.0916 |
| 1, 2, 9, 7, 4, 5, 3, 8 | 0.0963 |
| 1, 2, 9, 7, 4, 5, 3, 8, 10 | 0.1057 |

As may be seen from Table 2, the minimum damping ratio may be regarded as the performance index of the power system, and the square integral value of dynamic deviation may also be regarded as the performance index of the power system. With the increasing number of PSS in the power system, the minimum damping ratio is increasing, and the square integral value of dynamic deviation is decreasing, showing that the stability of power system is getting better and better with the increase of PSS in the power system.

In the process of PSS configuration of for the power system by the electronic equipment according to the dynamic deviation value of time-weighted gradient of the state variable curve, the electronic equipment verifies the stability of power system based on Liapunov's direct method for low-frequency oscillation caused by small interference. In the prior art, the 6# unit of the New England 10-machine 39-node system is equivalent, and PSS is not required. The dynamic damping ratio configuration method may be used to determine the location of PSS configuration, so as to optimize the small disturbance stability of the power system. In the disclosure, the electronic equipment uses MATLAB software Simulink to build a simulation system corresponding to the New England 10-machine 39-node system, and builds a small interference signal module for the 6# unit in the simulation system to simulate the low-frequency oscillation of the simulation system when the simulation system is subjected to small interference, so as to analyze the small disturbance stability of the simulation system.

The electronic equipment involved in the disclosure uses the obtained dynamic deviation value of time-weighted gradient of the state variable curve to describe the dynamic process of low-frequency oscillation of the generator set after the simulation system suffers from the small interference, and by comparing the dynamic deviation values of low-frequency oscillation of different generator sets in the simulation system, PSS is configured for the generator set with large oscillation amplitude and long oscillation time in the simulation system. Then in order to further verify the feasibility and effectiveness of the above-mentioned dynamic deviation value of time-weighted gradient of the state variable curve for PSS configuration, the electronic equipment configures the PSS of the simulation system according to the square integral value of power angle dynamic deviation obtained by Liapunov's direct method.

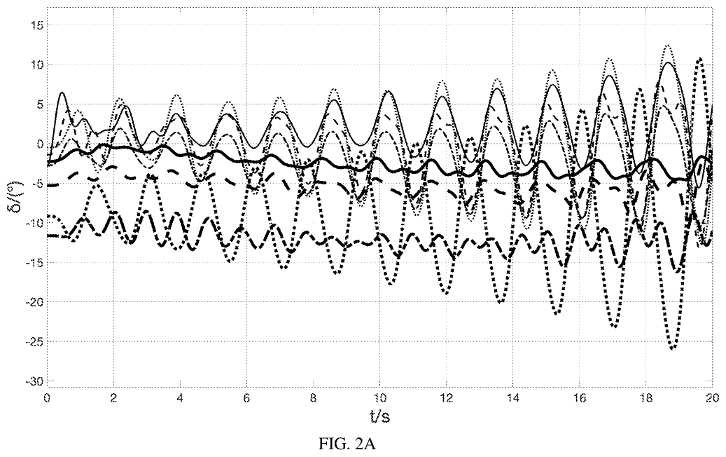

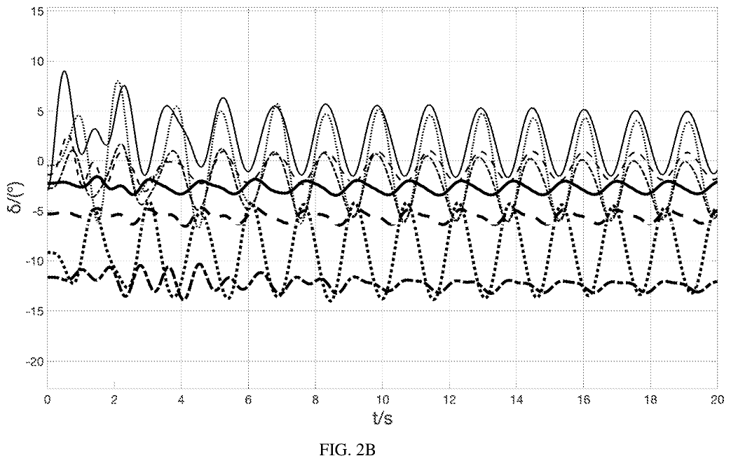

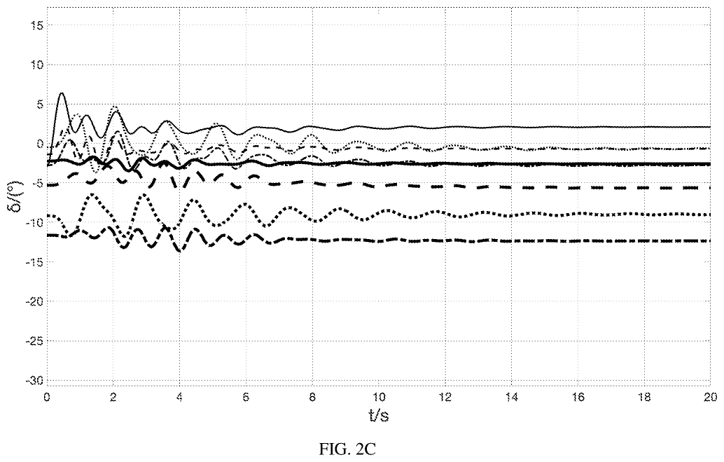

As shown in Table 3, it is a table showing time-weighted gradient deviations of the state curves of generator sets in the simulation system provided by the present disclosure, and as shown in FIG. 2A, it is a power angle oscillation graph corresponding to each generator set in the simulation system provided by the present disclosure when PSS is not configured.

TABLE 3

| | Dynamic deviation value of |
|---|---|
| Generator set number | gradient of state curve |
| 1# | 0.03569 |
| 2# | 0.02602 |
| 3# | 0.03271 |
| 4# | 0.07179 |
| 5# | 0.08368 |
| 7# | 0.05546 |
| 8# | 0.06102 |
| 9# | 0.04219 |
| 10# | 0.04847 |

As may be seen from Table 3, the time-weighted gradient deviations of the state curves corresponding to different generator sets are different. The generator sets configured with PSS in the power system should be No. 4#, No. 5#, No. 7#, No. 8# and No. 10# respectively; at the same time, the electronic equipment may compare the PSS configuration of generator sets by using the configuration criterion of dynamic minimum damping ratio. The method for configuring the damping stability controller in the simulation system provided by the disclosure may improve the small disturbance stability of the simulation system. In addition, different PSS configuration schemes are adopted for the same simulation system, and the oscillation curves obtained by the different PSS configuration schemes may directly reflect the dynamic process of oscillation and effectively improve the small disturbance stability of the simulation system.

As may be seen from FIG. 2A, the power angle oscillation curves corresponding to different generator sets when PSS is not configured are also different.

As shown in FIG. 2B, it is a graph showing oscillation curves respectively corresponding to different power units in the power system unconfigured with PSS provided by the present disclosure. FIG. 2C is a graph showing oscillation curves respectively corresponding to power systems configured with different PSS provided by the present disclosure.

By comparing FIG. 2B with FIG. 2C, it may be seen that the stability of the power system configured with PSS is higher than the stability of the power system unconfigured with PSS, and the power angle fluctuation degree of the power system configured with PSS is obviously lower than the stability of the power system of the power system unconfigured with PSS, showing that the configuration method based on dynamic damping ratio and the configuration method based on the time-weighted deviation values of the state curves of the electronic equipment are effective to some extent.

In addition, the power angle deviation time-weighted value may effectively reflect the oscillation amplitude of all generator sets in the time interval, thus reflecting the dynamic process of power system operation more comprehensively. Compared with the oscillation curve in FIG. 2B, based on the oscillation curve in FIG. 2C, the low-frequency oscillation process of the power system in which the electronic equipment is configured according to PSS with time-weighted deviation of the state curve is significantly shortened, and the oscillation amplitude is effectively reduced.

To sum up, the PSS configuration method of the electronic equipment according to the time-weighted deviation of the state curve involved in this disclosure is effective and feasible in a specific situation.

The device for detecting the stability of the generator set provided by the present disclosure is described below, and the device for detecting the stability of the generator set described below and the method for detecting the stability of the generator set described above may refer to each other correspondingly.

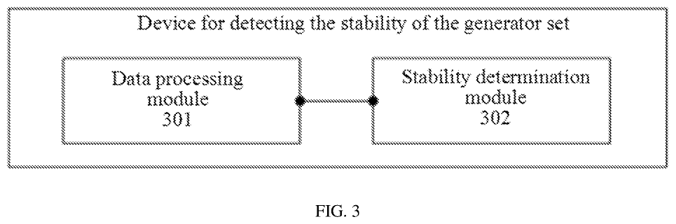

As shown in FIG. 3, it is a structural schematic diagram of the device for detecting the stability of the generator set provided by the present disclosure, including:
a data processing module 301 used for determining a target matrix by using Liapunov's direct method based on a state space matrix corresponding to PMU data; obtaining a state deviation corresponding to the PMU data and an oscillation curve corresponding to the state deviation in a case of determining the power system being in a stable state according to the target matrix ; and determining extreme point values corresponding to the oscillation curve at each oscillation; and
a stability determination module 302 used for evaluating a working state of the generator set in the power system according to the extreme point values.

Optionally, the data processing module 301 is specifically used for determining the state space matrix according to the acquired PMU data and based on a generator state space model; analyzing the state space matrix by using Liapunov's direct method and determining the target matrix.

Optionally, the stability determination module 302 is specifically used for determining the power system being in the stable state under a condition of determining the target matrix being a positive definite matrix.

A first extreme point value corresponding to a peak and a second extreme point value corresponding to a trough of the oscillation curve at each oscillation are determined by using a gradient descent method.

Optionally, the stability determination module 302 is specifically used for performing a weighted summation on each extreme point data to obtain an extreme value deviation; evaluating the working state of the generator set in the power system according to the extreme value deviation.

Optionally, the stability determination module 302 is specifically used for determining that an oscillation degree of the generator set in the power system is not severe when the extreme value deviation is less than a preset deviation threshold; and determining that the oscillation degree of the generator set is severe when the extreme value deviation is greater than or equal to the preset deviation threshold.

Optionally, the stability determination module 302 is specifically used for summarizing the acquired PMU data to obtain power grid data; carrying out a dimensionality reduction pretreatment on the power grid data to obtain a data matrix; and determining the state space matrix according to the data matrix and based on the generator state space model.

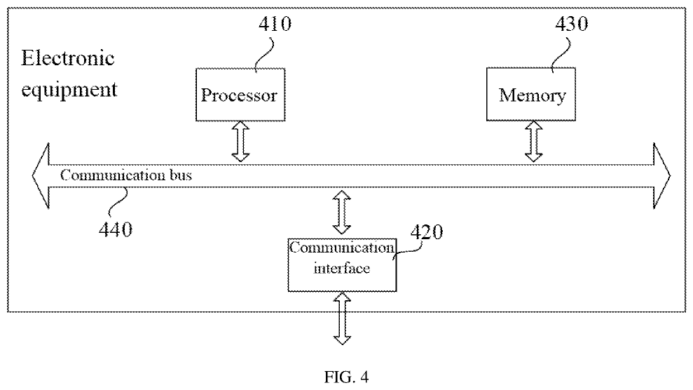

As shown in FIG. 4, it is a schematic structural diagram of electronic equipment provided by the present disclosure. The electronic equipment may include a processor 410, a communication interface 420, a memory 430 and a communication bus 440, where the processor 410, the communication interface 420 and the memory 430 communicate with each other through the communication bus 440. The processor 410 may call logic instructions in the memory 430 to execute the method for detecting the stability of the generator set in the power system, the method includes: determining a target matrix by using Liapunov's direct method based on a state space matrix corresponding to PMU data; obtaining a state deviation corresponding to the PMU data and an oscillation curve corresponding to the state deviation in a case of determining the power system being in a stable state according to the target matrix; determining extreme point values corresponding to the oscillation curve at each oscillation; and evaluating a working state of the generator set in the power system according to the extreme point values.

In addition, the above-mentioned logical instructions in the memory 430 may be realized in the form of software functional units and may be stored in a computer-readable storage medium when the above-mentioned logical instructions are sold or used as independent products. Based on this understanding, the technical solution of the disclosure, or the part that contributes to the prior art or the part that contributes to the technical solution may be embodied in the form of software product, the computer software product is stored in a storage medium and includes instructions to enable a computer device (may be a personal computer, server, or network device, etc.) to perform all or part of the steps of the method described in various embodiments of the disclosure. The aforementioned storage media include: U disk, mobile hard disk, Read-Only Memory (ROM), Random Access Memory (RAM), magnetic disk or optical disk and other media that may store program codes.

On the other hand, the disclosure also provides a computer program product, the computer program product includes a computer program, the computer program may be stored on a non-transient computer-readable storage medium, and when the computer program is executed by a processor, the computer may execute the method for detecting the stability of the generator set in the power system provided by the above methods, and the method includes the following steps: determining a target matrix by using Liapunov's direct method based on a state space matrix corresponding to PMU data; obtaining a state deviation corresponding to the PMU data and an oscillation curve corresponding to the state deviation in a case of determining the power system being in a stable state according to the target matrix; determining extreme point values corresponding to the oscillation curve at each oscillation; and evaluating a working state of the generator set in the power system according to the extreme point values.

On the another hand, the disclosure also provides a non-transient computer-readable storage medium, and a computer program is stored on the non-transient computer-readable storage medium, and when the computer program is executed by the processor, the method for detecting the stability of the generator set in the power system provided by the above methods is realized, and the method comprises the following steps:
determining a target matrix by using Liapunov's direct method based on a state space matrix corresponding to PMU data; obtaining a state deviation corresponding to the PMU data and an oscillation curve corresponding to the state deviation in a case of determining the power system being in a stable state according to the target matrix; determining extreme point values corresponding to the oscillation curve at each oscillation; and evaluating a working state of the generator set in the power system according to the extreme point values.

The device embodiments described above are only schematic, in which the units described as separate components may or may not be physically separated, and the components displayed as units may or may not be physical units, that is, may be located in one place or distributed to multiple network units. Some or all of the modules may be selected according to actual needs to achieve the purpose of this embodiment. Ordinary technicians in this field may understand and implement it without creative labor.

From the description of the above embodiments, those skilled in the art may clearly understand that each embodiment may be realized by means of software and necessary general hardware platform, and of course it may also be realized by hardware. Based on this understanding, the essence of the above technical scheme or the part that has contributed to the prior art may be embodied in the form of a software product, which may be stored in a computer-readable storage medium, such as ROM/RAM, magnetic disk, optical disk, etc., and includes several instructions for making a computer device (may be a personal computer, a server, or a network device, etc.) execute the methods described in various embodiments or some parts of the embodiments.

Finally, it should be explained that the above embodiments are only used to illustrate the technical scheme of the present disclosure, but not to limit it; although the present disclosure has been described in detail with reference to the foregoing embodiments, those skilled in the art should understand that it is still possible to modify the technical solutions described in the foregoing embodiments, or to replace some technical features with equivalents; however, these modifications or substitutions do not make the essence of the corresponding technical solutions deviate from the spirit and scope of the technical solutions of various embodiments of the present disclosure.

What is claimed is:

1. A method for detecting stability of a generator set in a power system, comprising:
determining a target matrix by using Liapunov's direct method based on a state space matrix corresponding to power management unit (PMU) data;
obtaining a state deviation corresponding to the PMU data and an oscillation curve corresponding to the state deviation in a case of determining the power system being in a stable state according to the target matrix;
determining extreme point values corresponding to the oscillation curve at each oscillation; and
evaluating a working state of the generator set in the power system according to the extreme point values.

2. The method according to claim 1, wherein the determining the target matrix by using Liapunov's direct method based on the state space matrix corresponding to the PMU data comprises:
determining the state space matrix according to the PMU data and based on a generator state space model; and
analyzing the state space matrix by using Liapunov's direct method and determining the target matrix.

3. The method according to claim 1, wherein the determining the power system being in the stable state according to the target matrix comprises:
determining the power system being in the stable state under a condition of determining the target matrix being a positive definite matrix.

4. The method according to claim 3, wherein the determining the extreme point values corresponding to the oscillation curve at each oscillation comprises:
determining a first extreme point value corresponding to a peak and a second extreme point value corresponding to a trough of the oscillation curve at each oscillation by using a gradient descent method.

5. The method according to claim 1, wherein the evaluating the working state of the generator set in the power system according to the extreme point values comprises:
performing a weighted summation on each of the extreme point values to obtain an extreme value deviation; and
evaluating the working state of the generator set in the power system according to the extreme value deviation.

6. The method according to claim 5, wherein the evaluating the working state of the generator set in the power system according to the extreme value deviation comprises:
determining an oscillation degree of the generator set being not severe in the power system when the extreme value deviation is less than a preset deviation threshold; and
determining the oscillation degree of the generator set being severe when the extreme value deviation is larger than or equal to the preset deviation threshold.

7. The method according to claim 2, wherein the determining the state space matrix according to the PMU data and based on the generator state space model comprises:
summarizing the acquired PMU data to obtain power grid data;
carrying out a dimensionality reduction pretreatment on the power grid data to obtain a data matrix; and
determining the state space matrix according to the data matrix and based on the generator state space model.

8. A device for detecting stability of a generator set, comprising:
a data processing module used for determining a target matrix by using Liapunov's direct method based on a state space matrix corresponding to power management unit (PMU) data;
obtaining a state deviation corresponding to the PMU data and an oscillation curve corresponding to the state deviation in a case of determining the power system being in a stable state according to the target matrix; and determining extreme point values corresponding to the oscillation curve at each oscillation; and
a stability determination module used for evaluating a working state of the generator set in the power system according to the extreme point values.

9. Electronic equipment and a non-transient computer-readable storage medium, the electronic equipment comprising a memory, a processor and a computer program stored in the memory and executable on the processor, the computer program being stored in the non-transient computer-readable storage medium, wherein when the processor executes the computer program, the method for detecting the stability of the generator set in the power system according to claim 1 is realized.
